(19) United States
(12) Patent Application Publication
(10) Pub. No.: US 2026/0301149 A1
(43) Pub. Date: Oct. 1, 2026

(54) SERVER AND METHOD

(71) Applicant: TOSHIBA TEC KABUSHIKI KAISHA, Tokyo (JP)

(72) Inventor: Yasuhiro AKASHI, Mishima Shizuoka (JP)

(73) Assignee: TOSHIBA TEC KABUSHIKI KAISHA, Tokyo (JP)

(21) Appl. No.: 19/545,367

(22) Filed: Feb. 20, 2026

(30) Foreign Application Priority Data
Mar. 26, 2025 (JP) 2025-052458

(51) Int. Cl. G06T 7/00; G02B 27/01; G06F 3/01; G06F 18/22; G06F 40/30

(52) U.S. Cl. CPC G06T 7/0004; G02B 27/017; G06F 3/017; G06F 18/22; G06F 40/30; G02B 2027/0178

(57) ABSTRACT

A server includes at least one processor coupled with at least one memory device storing instructions that, when executed by the at least one processor, cause the server to perform operations. The operations include receiving an image captured based on a pointing and calling action, generating an explanatory sentence based on the image, and calculating similarity degrees between the explanatory sentence and a plurality of work item sentences, the plurality of work item sentences including items for a check procedure. The operations include determining a combination of the explanatory sentence and a work item sentence of the plurality of work item sentences having a highest similarity degree relative to combinations of the explanatory sentence and other work item sentences of the plurality of work item sentences, and enabling alert information based on the similarity degree of the explanatory sentence and the work item sentence being lower than a threshold.

### CROSS-REFERENCE TO RELATED PATENT APPLICATIONS

This application is based upon and claims the benefit of and priority to Japanese Patent Application No. 2025-052458, filed on Mar. 26, 2025, the entire contents of which are incorporated herein by reference.

### FIELD

Embodiments described herein relate generally to a server and a method.

### BACKGROUND

Information processing devices and a programs for imaging a working state of an operator as a moving image, generating an explanatory sentence from an image extracted from the moving image, specifying the order of execution of work by the operator based on similarity degrees between the explanatory sentence and explanatory sentence of processes described in a work procedure manual, and detecting the difference between the description of the work procedure manual and the work of the operator are known. Checking work for equipment and operations by visual inspection is performed in a manufacturing site, a factory, and the like. There is also a site where, for raising awareness and reducing mistakes of an operator, the operator is required to perform pointing and calling if carrying out a visual check. The pointing and calling is an action of pointing a check target and uttering check content, implementation of a check, and the like. However, even if the operator performs the pointing and calling, there is a problem in that it is difficult to check whether the check work was correctly performed.

### BRIEF DESCRIPTION OF THE DRAWINGS

FIG. 1 is a block diagram illustrating a configuration example of an information processing system according to an embodiment.

FIG. 2 is a diagram illustrating an example of a user wearing smart glasses and a band according to an embodiment.

FIG. 3 is a block diagram illustrating an example configuration of the smart glasses and the band.

FIG. 4 is a block diagram illustrating an example configuration of a server according to an embodiment.

FIG. 5 is a block diagram illustrating an example configuration of a terminal according to an embodiment.

FIG. 6 is a flowchart illustrating an example of a pointing and calling detection operation of the band.

FIG. 7 is a flowchart illustrating an example of an imaging operation of the smart glasses.

FIG. 8 is a flowchart illustrating an example of an image saving operation of the server.

FIG. 9 is a diagram illustrating an example of an operation screen of the information processing system.

FIG. 10 is a diagram illustrating an example of the operation screen.

FIG. 11 is a diagram illustrating an example of the operation screen.

FIG. 12 is a flowchart illustrating an example of an evidence creation operation of the server.

FIG. 13 is a diagram illustrating an example of explanatory sentence creation by generative AI in the server.

FIG. 14 is a diagram illustrating an example of a feature space of feature vectors in the server.

FIG. 15 is a diagram illustrating an example of work implementation evidence of the information processing system.

FIG. 16 is a diagram illustrating an example of the work implementation evidence.

FIG. 17 is a flowchart illustrating an example of an alert detection operation of the server.

### DETAILED DESCRIPTION

An object of the embodiments is to provide a function of being able to detect a case in which it is doubtful whether a check by pointing and calling was correctly performed.

In general, according to one embodiment, a server includes a reception processing unit, a generation processing unit, a similarity degree processing unit, and an alert processing unit. The reception processing unit receives an image captured based on a pointing and calling action. The generation processing unit generates an explanatory sentence from the image received by the reception processing unit. The similarity degree processing unit calculates similarity degrees between the generated explanatory sentence and work item sentences, which are sentences of items included in a check procedure and finds a combination having a highest similarity degree. The alert processing unit enables alert information if the similarity degree of the found combination is lower than a threshold.

An embodiment is explained below with reference to the drawings. In the explanation, constituent elements having substantially the same functions and configurations are denoted by the same reference numerals and signs. The embodiments explained below exemplifies a technical idea. The embodiments do not specify the material, the shape, the structure, the disposition, and the like of constituent components. Various changes can be applied to the embodiments described herein.

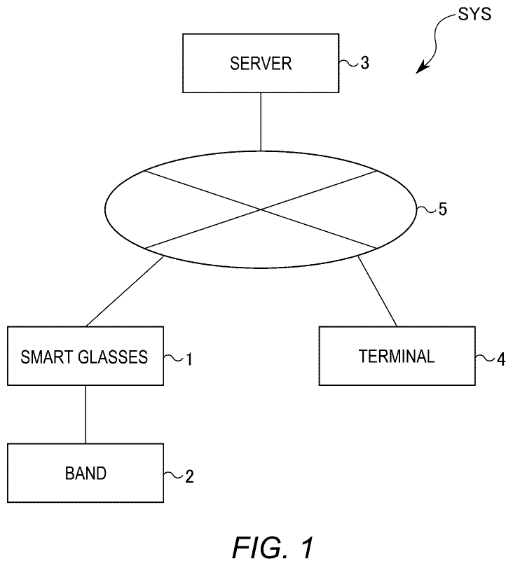

FIG. 1 is a block diagram illustrating a configuration example of an information processing system according to an embodiment. An information processing system SYS is a system that records check by pointing and calling, creates evidence of implementing a check work action, and detects a case in which it is doubtful whether the check was correctly performed. As illustrated in FIG. 1, the information processing system SYS includes smart glasses 1, a band 2, a server 3, and a terminal 4. Each of the smart glasses 1, the server 3, and the terminal 4 is connected to a network 5.

The smart glasses 1 are a device that records a state of pointing and calling in a site of the check work. The smart glasses 1 are a computer that can be worn.

The band 2 is a device that detects an operator having executed pointing and calling. The band 2 is a device that can be worn. The band 2 is connected to the smart glasses 1.

The server 3 (e.g., controller, control system, control device, etc.) is an information processing device that controls an operation of the entire information processing system SYS. For example, the server 3 can be a computer.

The terminal 4 is a device used if processing to be executed by the server 3 is set and if a result of the executed processing is referred to. For example, the terminal 4 can be a computer.

The network 5 is, for example, a wired line or a wireless line, a LAN (Local Area Network), the Internet, a telephone communication network, or another independent communication network or a communication line configured by single communication means including the foregoing or configured by combining communication means including the foregoing.

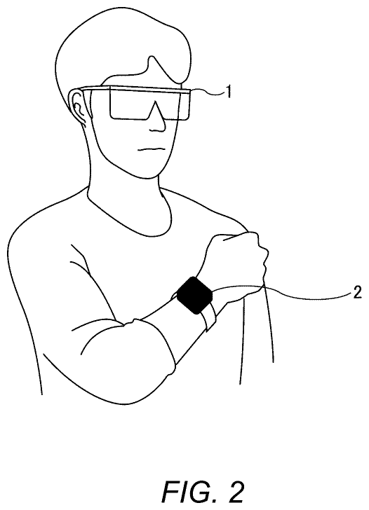

FIG. 2 is a diagram illustrating an example of a user wearing a pair of the smart glasses1 and the band 2 according to an embodiment. As illustrated in FIG. 2, the smart glasses 1 are a device having a shape like an eyeglasses shape and are used by being worn on a face by the operator. The band 2 is a device having a shape like a wristwatch shape and is used by being worn on a wrist of an arm, for example, a wrist of a right arm with which the operator performs a pointing action if performing pointing and calling.

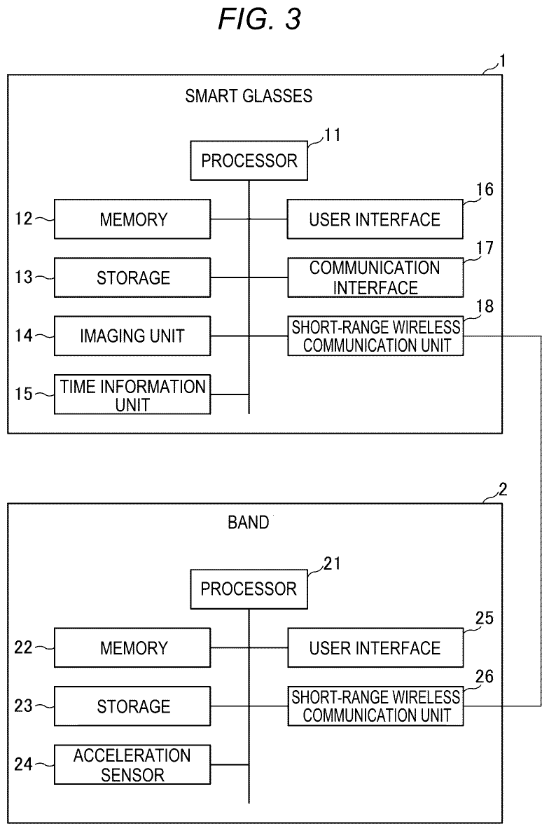

FIG. 3 is a block diagram illustrating a configuration example of the smart glasses and the band according to an embodiment. The smart glasses 1 can be implemented by a computer (e.g., a controller, control system, control device, etc.) including one or more processors, a memory, a storage, and an interface. As illustrated in FIG. 3, the smart glasses 1 include a processor 11, a memory 12, a storage 13, an imaging unit 14, a time information unit 15, a user interface 16, a communication interface 17, and a short-range wireless communication unit 18.

The processor 11 includes a CPU (Central Processing Unit). The processor 11 executes various kinds of processing based on a control program and control data stored in the memory 12. For example, the processor 11 executes an application program stored in the memory 12 to thereby cause the smart glasses 1 to receive information from the band 2, take an image or images of a state of pointing and calling, and transmit image data to the server 3.

The memory 12 includes a ROM (Read Only Memory), a RAM (Random Access Memory), and an NVM (Non-Volatile memory). The ROM and the NVM store the control program, the control data, and the like. The RAM functions as a work memory and stores temporary data.

The storage 13 stores data and the like used for information processing. The storage 13 may store the control program, the control data, and the like.

The imaging unit 14 includes an image sensor. The imaging unit 14 performs imaging to cover at least a portion of a field of view of the operator wearing the smart glasses 1 and generates image data.

The time information unit 15 includes a real time clock. The time information unit 15 outputs the current year, month, and data and time.

The user interface 16 exchanges information with a wearer of the smart glasses 1. The user interface 16 includes, for example, a display that displays information in the visual field of the wearer and a button for receiving input from the wearer.

The communication interface 17 is connected to the network 5 and transmits and receives data to and from the server 3 via the network 5.

The short-range wireless communication unit 18 performs wireless communication with a device in the vicinity. A scheme of communication performed by the short-range wireless communication unit 18 is, for example, Bluetooth (registered trademark). The short-range wireless communication unit 18 performs communication with the band 2.

A configuration of the band 2 is explained subsequently with reference to FIG. 3. As illustrated in FIG. 3, the band 2 includes a processor 21, a memory 22, a storage 23, an acceleration sensor 24, a user interface 25, and a short-range wireless communication unit 26.

The processor 21 includes a CPU. The processor 21 executes various kinds of processing based on a control program and control data stored in the memory 22. For example, the processor 21 executes an application program stored in the memory 22 to thereby detect a pointing and calling action based on a measurement value of the acceleration sensor 24 and controls the short-range wireless communication unit 26 to perform communication with the smart glasses 1.

The memory 22 includes a ROM, a RAM, and an NVM. The ROM and the NVM store the control program, the control data and the like. The RAM functions as a work memory and stores temporary data.

The storage 23 stores data and the like used for information processing. The storage 23 may store the control program, the control data, and the like.

The acceleration sensor 24 detects the acceleration of the band 2 (e.g., due to motion of the wrist of the user wearing the band 2).

The user interface 25 (e.g., input/output device, operator interface, etc.) exchanges information with a wearer of the band 2. The user interface 25 includes, for example, an LED (Light Emitting Diode) indicating an operation status of the band 2 and a button for receiving input from the wearer.

The short-range wireless communication unit 18 performs wireless communication with a device (e.g., a band 2) in the vicinity of the smart glasses 1. A scheme of communication performed by the short-range wireless communication unit 18 is, for example, Bluetooth (registered trademark). The short-range wireless communication unit 18 performs communication with the smart glasses 1.

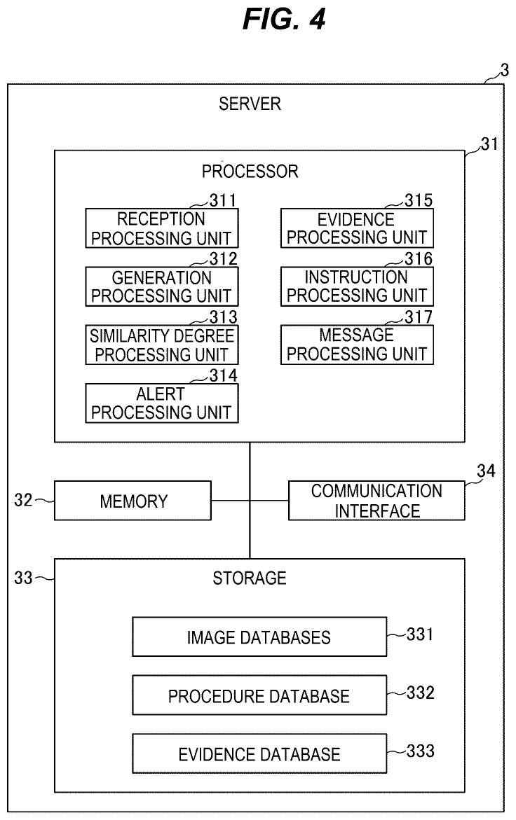

FIG. 4 is a block diagram illustrating a configuration example of the server according to an embodiment. The server 3 can be implemented by a computer (e.g., a computing device, a controller, a control unit, a control device, etc.) including one or more processors, a memory, a storage, and an interface. As illustrated in FIG. 4, the server 3 includes a processor 31, a memory 32, a storage 33, and a communication interface 34.

The processor 31 includes a CPU. The processor 31 may be coupled with the memory 32. For example, the processor 31 executes various kinds of processing based on a control program and control data stored in the memory 32. For example, the processor 31 executes an application program stored in the memory 32 to thereby receive image data obtained by imaging a state of pointing and calling, link the image data with a check item, enable alert information according to a situation, and execute processing based on the alert information.

The memory 32 includes a ROM, a RAM, and an NVM. The ROM and the NVM store the control program, the control data, and the like. The RAM functions as a work memory and stores temporary data.

The storage 33 (e.g., a data store, a database, a storage base, etc.) stores data and the like used for information processing. The storage 33 may store the control program, the control data, and the like. The storage 33 stores at least an image database 331, a procedure database 332, and an evidence database 333. The image database 331 is a database in which image data obtained from the smart glasses 1 by imaging a state of pointing and calling is stored. The procedure database 332 is a database in which check items to be checked by performing pointing and calling actions are stored. The evidence database 333 is a database in which evidence indicating that pointing and calling action was implemented to perform a check is stored.

The communication interface 34 is connected to the network 5 and transmits and receives data to and from the smart glasses 1 and the terminal 4 via the network 5.

The processor 31 (e.g., of a controller implementing the server 5) executes an application program to thereby implement a reception processing unit 311, a generation processing unit 312, a similarity degree processing unit 313, an alert processing unit 314, an evidence processing unit 315, an instruction processing unit 316, and a message processing unit 317 as functional units.

The reception processing unit 311 receives an image captured based on a pointing and calling action.

The generation processing unit 312 generates an explanatory sentence from the image received by the reception processing unit 311.

The similarity degree processing unit 313 calculates similarity degrees between the generated explanatory sentence and work item sentences, which are sentences of items included in a check procedure and finds a combination having the highest similarity degree.

If the similarity degree of the found combination is lower than a threshold, the alert processing unit 314 enables alert information (e.g., transmits an alert).

The evidence processing unit 315 combines a set of the work item sentence corresponding to the found combination and the image, time information, and, if enabled, the alert information and generates work implementation evidence indicating that the check procedure was implemented.

If the alert information was enabled, the instruction processing unit 316 outputs, to external equipment, an instruction for causing the external equipment to notify a user.

If the alert information was enabled, the message processing unit 317 transmits a message to the external equipment.

Details of the functional units are explained below.

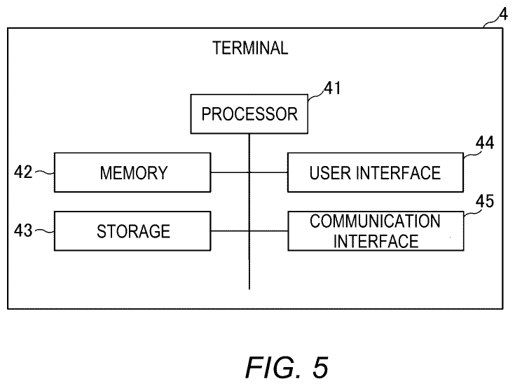

FIG. 5 is a block diagram illustrating a configuration example of a terminal according to an embodiment. The terminal 4 can be implemented by a computer (e.g., controller, control system, control device, etc.) including one or more processors, a memory, a storage, and an interface. As illustrated in FIG. 5, the terminal 4 includes a processor 41, a memory 42, a storage 43, a user interface 44, and a communication interface 45.

The processor 41 includes a CPU. The processor 41 executes various kinds of processing based on a control program and control data stored in the memory 42. For example, the processor 41 executes an application program stored in the memory 42 to thereby exchange information with the server 3 and performs setting of a check procedure and display of work implementation evidence.

The memory 42 includes a ROM, a RAM, and an NVM. The ROM and the NVM store the control program and the control data. The RAM functions as a work memory and stores temporary data.

The storage 43 stores data and the like used for information processing. The storage 43 may store the control program, the control data, and the like.

The user interface 44 exchanges information with a user of the terminal 4. The user interface 44 (e.g., the operator interface, the input/output device, etc.) includes, for example, a touch panel display.

The communication interface 45 is connected to the network 5 and transmits and receives data to and from the server 3 via the network 5.

Operations of the units of the information processing system SYS according to an embodiment are explained below. First, it is explained how image data obtained from the smart glasses 1 by imaging a state of pointing and calling is captured and stored in the server 3. Subsequently, various screens that the terminal 4 can display by communicating with the server 3 are explained. Finally, it is explained how work implementation evidence is created in the server 3 and what kind of an operation is executed based on the alert information.

It is explained how a state of pointing and calling is imaged and image data is stored in the server 3. Until the image data is stored in the server 3, roughly divided, detection of pointing and calling by the band 2, imaging by the smart glasses 1, and saving by the server 3 are executed.

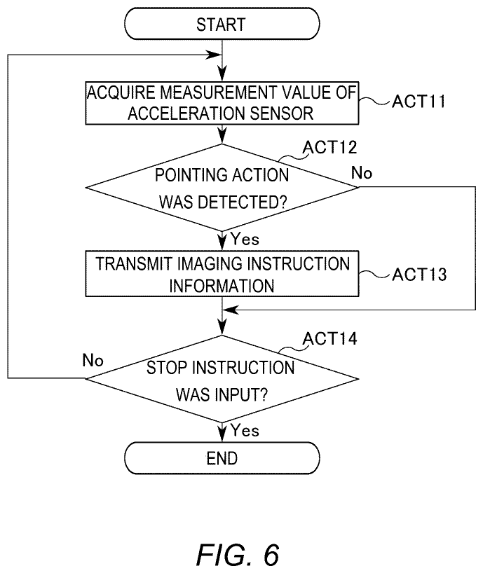

The detection of pointing and calling by the band 2 is explained. FIG. 6 is a flowchart illustrating an example of a pointing and calling detection operation of the band 2 according to an embodiment. If the pointing and calling detection operation is started by, for example, the user interface 25 of the band 2 being operated (e.g., by user input), the band 2 acquires a measurement value of an acceleration sensor (ACT11). Specifically, the processor 21 of the band 2 acquires a measurement value of the acceleration sensor 24.

The band 2 determines whether a pointing action was detected (ACT12). Specifically, the processor 21 analyzes the measurement value of the acceleration sensor 24 acquired in the processing in ACT11 and determines whether the pointing action was detected.

If the pointing action was detected (ACT12, Yes), the band 2 transmits imaging instruction information to the smart glasses 1 (ACT13). Specifically, the processor 21 controls the short-range wireless communication unit 26 to transmit the imaging instruction information to the smart glasses 1.

If the pointing action was not detected in the processing in ACT12 (ACT12, No) and if the processing in ACT13 ended, the band 2 determines whether a stop instruction was input (ACT14). Specifically, the processor 21 determines whether the stop instruction was input by, for example, the user interface 25 being operated.

If the stop instruction was not input (ACT14, No), the band 2 executes the processing in ACT11. That is, the band 2 repeatedly executes the processing in ACT11 to ACT14 until the stop instruction is input. Accordingly, the band 2 can monitor the measurement value of the acceleration sensor 24 and transmit the imaging instruction information to the smart glasses 1 every time the band 2 detects the pointing action.

If the stop instruction was input in the processing in ACT14 (ACT14, Yes), the series of processing illustrated in FIG. 6 ends.

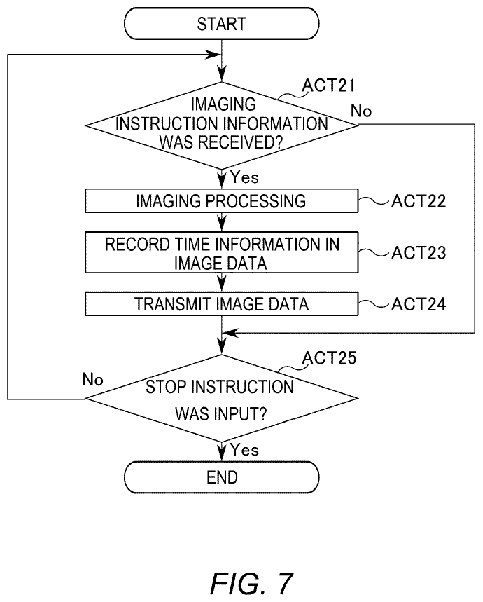

Imaging by the smart glasses 1 is explained. FIG. 7 is a flowchart illustrating an example of an imaging operation of the smart glasses according to an embodiment. If the imaging operation is started by, for example, the user interface 16 of the smart glasses 1 being operated, the smart glasses 1 may determine whether the imaging instruction information was received from the band 2 (ACT21). Specifically, the processor 11 of the smart glasses 1 determines whether the short-range wireless communication unit 18 received the imaging instruction information from the band 2.

If the imaging instruction information was received (ACT21, Yes), the smart glasses 1 execute imaging processing (ACT22). Specifically, the processor 11 controls the imaging unit 14 to capture an image and acquire image data and stores the acquired image data in the storage 13.

The smart glasses 1 record time information in the image data (ACT23), such that the image includes associated time information. Specifically, the processor 11 controls the time information unit 15 to acquire time information. Then, the processor 11 records the acquired time information in the image data stored in the storage 13 in the processing in ACT22.

The smart glasses 1 transmit the image data (ACT24). Specifically, the processor 11 controls the communication interface 17 to transmit the image data stored in the storage 13 in the processing in ACT22 and ACT23 to the server 3.

If the imaging instruction information was not received in the processing in ACT21 (ACT21, No) and if the processing in ACT24 ended, the smart glasses 1 determine whether a stop instruction was input (ACT25). Specifically, the processor 11 determines whether the stop instruction was input by, for example, the user interface 16 of the smart glasses 1 being operated.

If the stop instruction was not input (ACT25, No), the smart glasses 1 execute the processing in ACT21. That is, the smart glasses 1 repeatedly execute the processing in ACT21 to ACT25 until the stop instruction is input. Accordingly, every time the smart glasses 1 receive the imaging instruction information from the band 2, the smart glasses 1 can capture an image, record time information, and transmit image data to the server 3.

If the stop instruction was input in the processing in ACT25 (ACT25, Yes), the series of processing illustrated in FIG. 7 ends.

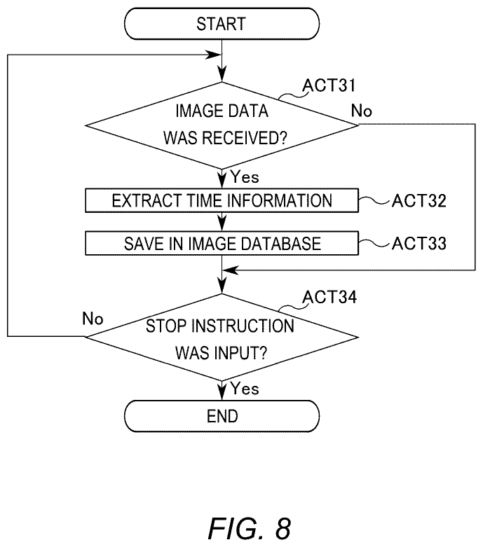

Saving by the server 3 is explained. FIG. 8 is a flowchart illustrating an example of an image saving operation of the server according to an embodiment. If the server 3 starts and the image saving operation is started, the server 3 determines whether the image data was received (ACT31). Specifically, the processor 31 of the server 3 determines whether the communication interface 34 received the image data.

If the image data was received (ACT31, Yes), the server 3 extracts the time information (ACT32). Specifically, the processor 31 extracts the time information recorded in the received image data transmitted to the server 3 by the smart glasses 1.

The server 3 saves the image data in the image database 331 (ACT33). Specifically, the processor 31 saves the received image data and the time information extracted from the image data in the image database 331 in association with each other.

If the image data was not received in the processing in ACT31 (ACT31, No) and if the processing in ACT33 ended, the server 3 determines that the stop instruction was input (ACT34). Specifically, the processor 31 determines whether the stop instruction was input via the communication interface 34.

If the stop instruction was not input (ACT34, No), the server 3 executes the processing in ACT31. That is, the server 3 repeatedly executes the processing in ACT31 to ACT34 until the stop instruction is input. Accordingly, every time the server 3 receives the image data, the server 3 can extract the time information from the image data and save the image data and the time information in the image database 331 in association with each other.

If the stop instruction was input in the processing in ACT34 (ACT34, Yes), the series of processing illustrated in FIG. 8 ends.

Various screens that the terminal 4 can display on the user interface 44 by communicating with the server 3 are explained. If the user operates the user interface 44 of the terminal 4, the terminal 4 communicates with the server 3 and displays various screens on the user interface 44. A mechanism of displaying the various screens is implemented by, for example, accessing the server 3 with a web browser (e.g., via a user device such as a desktop, a laptop, a mobile device, etc.). The user can perform creation and editing of a procedure to be treated by the information processing system SYS, creation of work implementation evidence, check of the work implementation evidence, and the like by operating the screens.

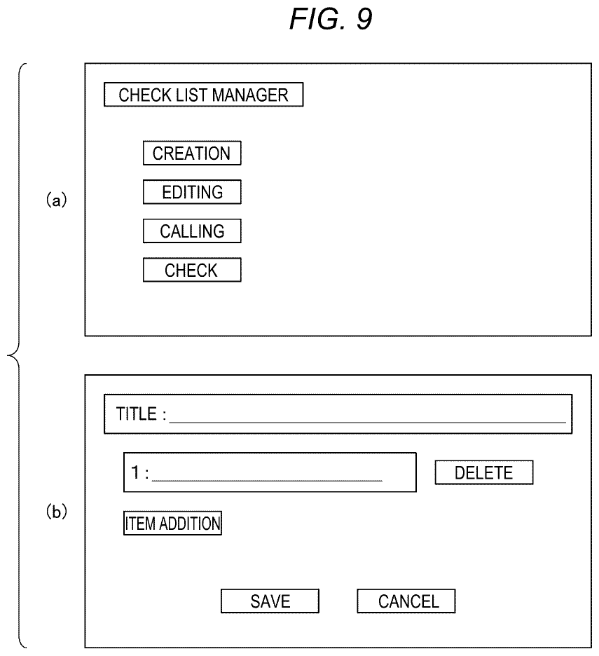

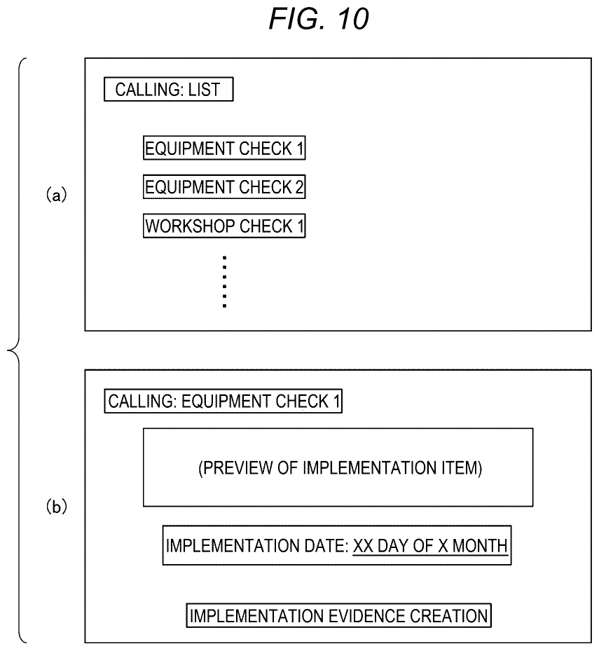

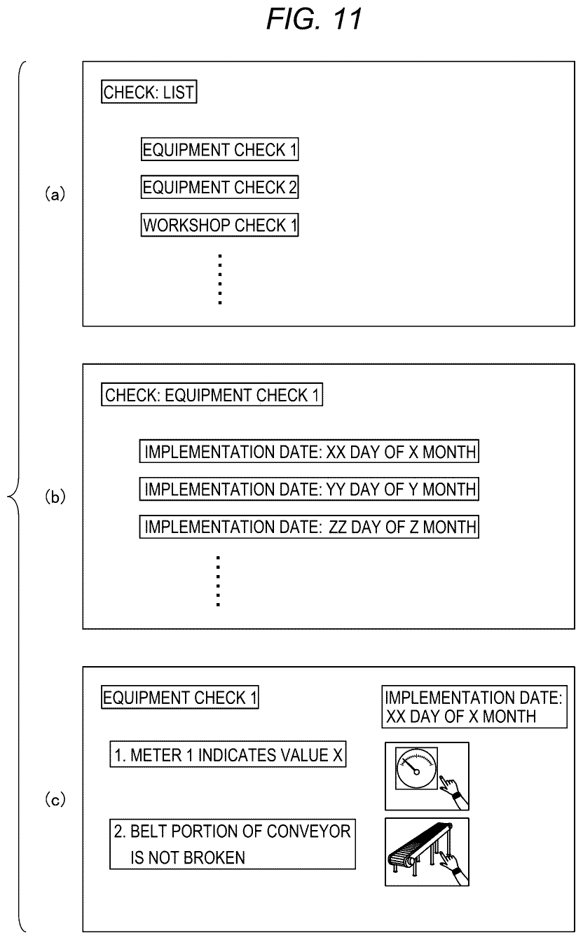

Each of FIG. 9, FIG. 10, and FIG. 11 is a diagram illustrating an example of an operation screen of the information processing system according to an embodiment. If the user operates the user interface 44 of the terminal 4 and accesses the server 3, a menu screen illustrated in (a) of FIG. 9 is displayed. A creation button, an editing button, a calling button, and a check button are shown to be displayed on the menu screen (a). The creation button is a button for transitioning to a screen for creating a procedure anew. The editing button is a button for transitioning to a screen for editing the created procedure. The calling button is a button for transitioning to a screen for creating work implementation evidence using the created procedure. The check button is a button for transitioning to a screen for checking the created work implementation evidence.

If the creation button is pressed on the menu screen, a creation screen illustrated in (b) of FIG. 9 is displayed. On the creation screen, a field for inputting a title of a procedure to be created, a field for inputting a first item of the procedure, a button for deleting the first item of the procedure, a button for adding an item of the procedure, a saving button for saving input content, and a cancel button for cancelling the creation and returning to the menu screen are displayed. It is possible to create a procedure corresponding to desired check work by inputting items from the creation screen explained above. The created procedure is saved in the procedure database 332.

If the calling button is pressed on the menu screen, a calling list illustrated in the screen (a) of FIG. 10 is displayed. Procedures saved in the procedure database 332 are displayed as a list on the list screen of calling. In the screen (a) of FIG. 10, equipment check 1, equipment check 2, and workshop check 1 are displayed. Here, if the equipment check 1 is selected, the calling list displayed on the screen (a) transitions to an equipment check 1 screen of calling illustrated in (b) of FIG. 10. On the equipment check 1 screen of calling, a region where a preview of an implementation item is displayed, a region where an implementation date is input, and an implementation evidence creation button are displayed. By inputting a work implementation date when the user desires to create work implementation evidence and pressing the implementation evidence creation button while confirming, with preview of an implementation item, that a desired procedure was selected, the user can create work implementation evidence corresponding to the selected procedure and the input implementation date. The created work implementation evidence is saved in the evidence database 333. The work implementation evidence is explained in detail after explanation of the screens.

If the check button is pressed on the menu screen, a check list screen illustrated in the screen (a) of FIG. 11 is displayed. On the check list screen, procedures corresponding to the work implementation evidence saved in the evidence database 333 are displayed as a list. In screen (a) of FIG. 11, equipment check 1, equipment check 2, and workshop check 1 are displayed. Here, if the equipment check 1 is selected, the check list screen transitions to an equipment check 1 screen illustrated in screen (b) of FIG. 11. On the equipment check 1 screen, a list of implementation dates corresponding to the equipment check 1, which is the selected procedure, among pieces of work implementation evidence saved in the evidence database 333 is displayed. In screen (b) of FIG. 11, XX day of X month, YY day of Y month, and ZZ day of Z month are displayed as the implementation dates. Here, if XX day of X month is selected, the equipment check 1 screen transitions to a work implementation evidence screen illustrated in screen (c) of FIG. 11. Work implementation evidence is displayed on the work implementation evidence screen. Details of the work implementation evidence are explained below.

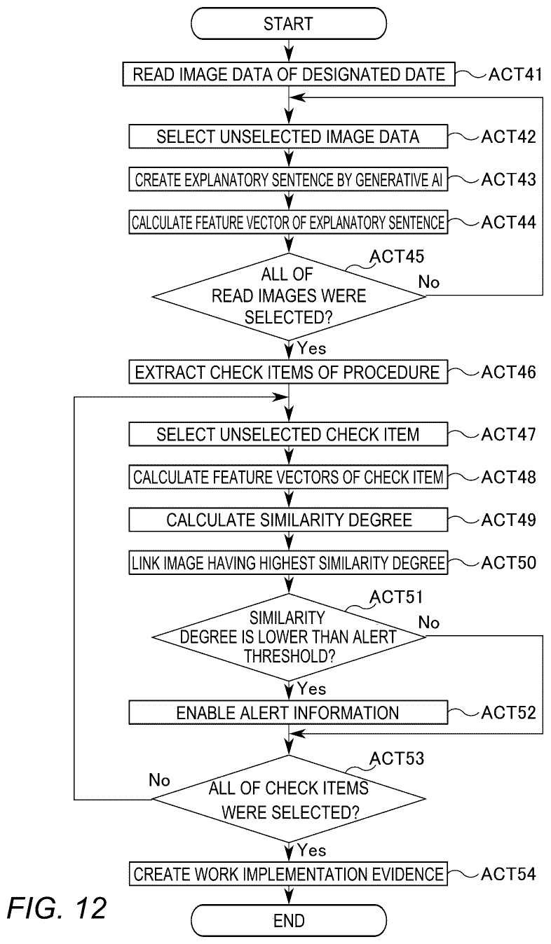

It is explained how work implementation evidence is created in the server 3 and what kind of an operation is executed based on alert information. FIG. 12 is a flowchart illustrating an example of an evidence creation operation of the server according to an embodiment. As explained with reference to screen (b) of FIG. 10, if the user instructs creation of work implementation evidence, the server 3 reads image data of a designated date (ACT41). Specifically, the processor 31 of the server 3 reads, from the image database 331, image data linked with time information of a date corresponding to an implementation date designated by the user.

The server 3 selects unselected image data (ACT42). Specifically, the processor 31 selects one piece of unselected image data among the image data read in the processing in ACT41.

The server 3 creates an explanatory sentence by generative AI (ACT43). Specifically, the processor 31 creates an explanatory sentence with the generative AI using the image data selected in the processing in ACT42.

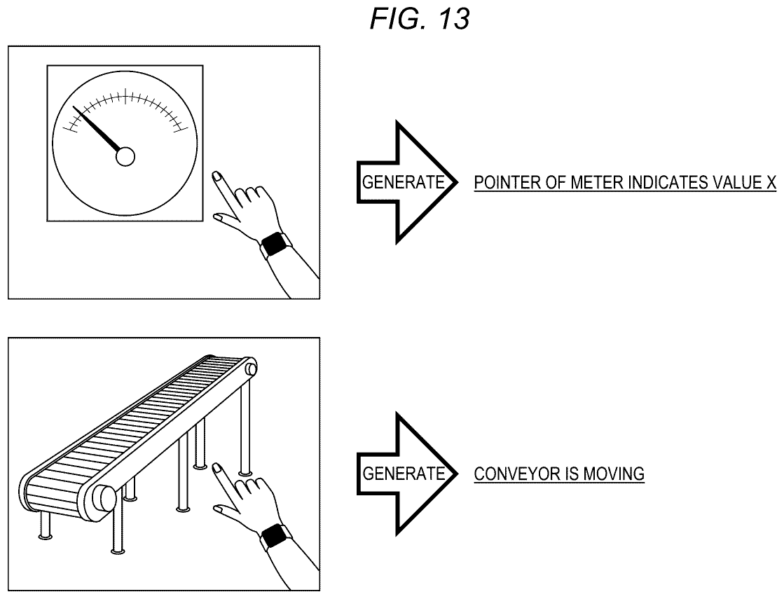

FIG. 13 is a diagram illustrating an example of explanatory sentence creation by the generative AI in the server according to the embodiment. As illustrated in an upper part of FIG. 13, if an explanatory sentence is generated from an image in which the user is pointing at a meter indicating a low value, a sentence “the pointer of the meter indicates a value X” is generated. As illustrated in a lower part of FIG. 13, if an explanatory sentence is generated from an image in which the user is pointing at a conveyor, a sentence “the conveyor is moving” is generated.

Referring back to FIG. 12, the server 3 calculates a feature vector of the explanatory sentence (ACT44). Specifically, the processor 31 calculates a feature vector for the explanatory sentence created in the processing in ACT43.

The server 3 determines whether all of read images were selected (ACT45). Specifically, the processor 31 determines whether all pieces of image data read in the processing in ACT41 were selected. If not all of the read images were selected (ACT45, No), the server 3 executes the processing in ACT42. That is, the server 3 repeatedly executes the processing in ACT42 to ACT45 until all of the read images are selected.

If all of the read images were selected in the processing in ACT45 (ACT45, Yes), the server 3 extracts check items of a procedure (ACT46). Specifically, the processor 31 reads, from the procedure database 332, a procedure selected by the user and extracts check items included in the procedure.

The server 3 selects an unselected check item (ACT47). Specifically, the processor 31 selects one unselected check item among the check items extracted in the processing in ACT46.

The server 3 calculates a feature vector of the check item (ACT48). Specifically, the processor 31 calculates a feature vector for a sentence of the selected check item.

The server 3 calculates similarity degrees (ACT49). Specifically, the processor 31 calculates similarity degrees between feature vectors of the read image data calculated in the processing in ACT44 and the feature vectors of the selected check item calculated in the processing in ACT48.

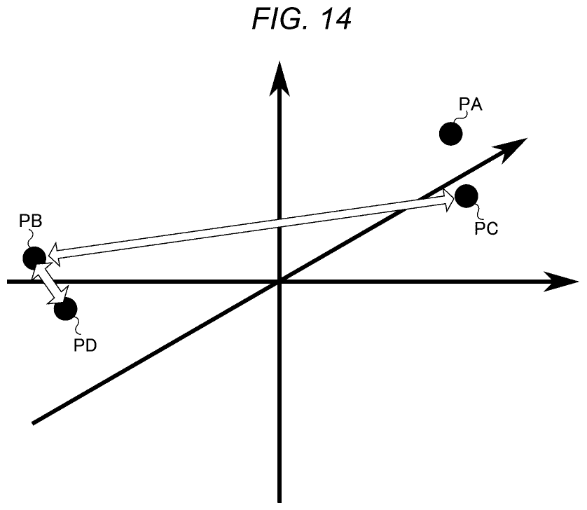

FIG. 14 is a diagram illustrating an example of a feature space of feature vectors in the server according to the embodiment. In FIG. 14, a case in which the feature space is three-dimensional is illustrated as an example. In FIG. 14, a point PA, a point PB, a point PC, and a point PD are illustrated on the feature space. Looking at the distances between the point PB and the other points, it is seen that the distance to the point PD is the shortest and the distance to the point PA and the distance to the point PC are longer than the distance to the point PD. By calculating the distances on the feature space in this way, it is possible to calculate similarity degrees for the feature vectors as well.

Referring back to FIG. 12, the server 3 links an image having the highest similarity degree (ACT50). Specifically, the processor 31 links image data having the highest similarity degree and the selected check item.

The server 3 determines whether the similarity degree is lower than an alert threshold (ACT51). Specifically, the processor 31 determines, for the image data and the check item linked in the processing in ACT50, whether the similarity degree of the feature vector is lower than the alert threshold.

If the similarity degree is lower than the alert threshold (ACT51, Yes), the server 3 enables alert information (ACT52)(e.g., triggers an alert, transmits an alert notification, etc.). Specifically, the processor 31 enables the alert information based on a set of the image and the check item linked in ACT50.

If the similarity degree is not lower than the alert threshold in the processing in ACT51 (ACT51, No) and if the processing in ACT52 ended, the server 3 determines whether all of the check items were selected (ACT53). Specifically, the processor 31 determines whether all of the check items extracted in the processing in ACT46 were selected. If not all of the check items were selected (ACT53, No), the server 3 executes the processing in ACT47. That is, the server 3 repeatedly executes the processing in ACT47 to ACT53 until all of the check items are selected. Accordingly, the server 3 can link all of the check items with an image having the highest similarity degree of the feature vector.

If all of the check items were selected in the processing in ACT53 (ACT53, Yes), the server 3 creates work implementation evidence (ACT54). The work implementation evidence is information of evidence indicating that a procedure was implemented, the information including at least an implementation date of work, a set of a check item and image data, and, if alert information of the set is enabled, the alert information. The created work implementation evidence is saved in the evidence database 333.

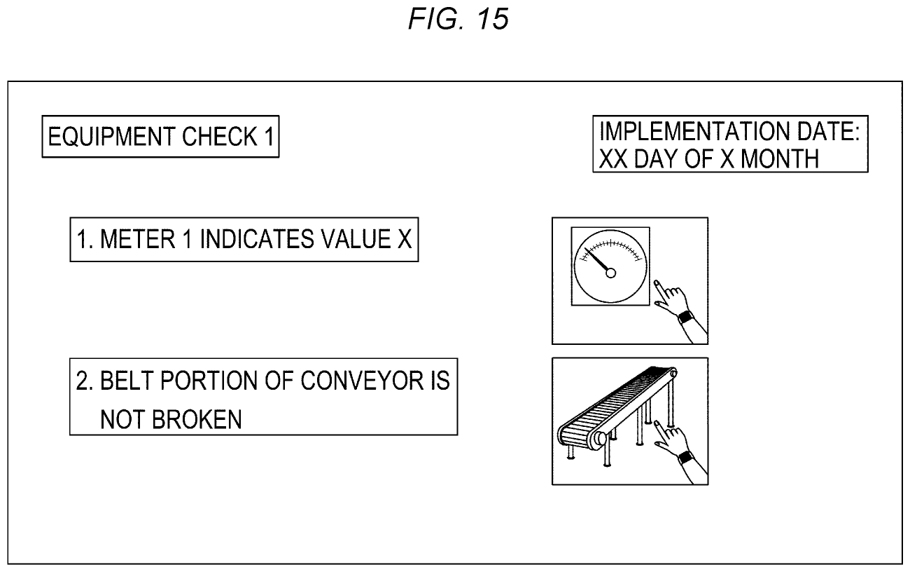

FIG. 15 is a diagram illustrating an example of work implementation evidence of the information processing system according to the embodiment. In the example illustrated in FIG. 15, evidence of work implemented on “XX day of X month” is illustrated for a procedure “equipment check 1”. Image data at the time when pointing and calling was performed is illustrated side by side with a first item “1. The meter 1 indicates the value X”. Alert is not displayed for the first item. Image data at the time when pointing and calling was performed is illustrated side by side with a second item “2. The belt portion of the conveyor is not broken”. Alert is not displayed for the second item.

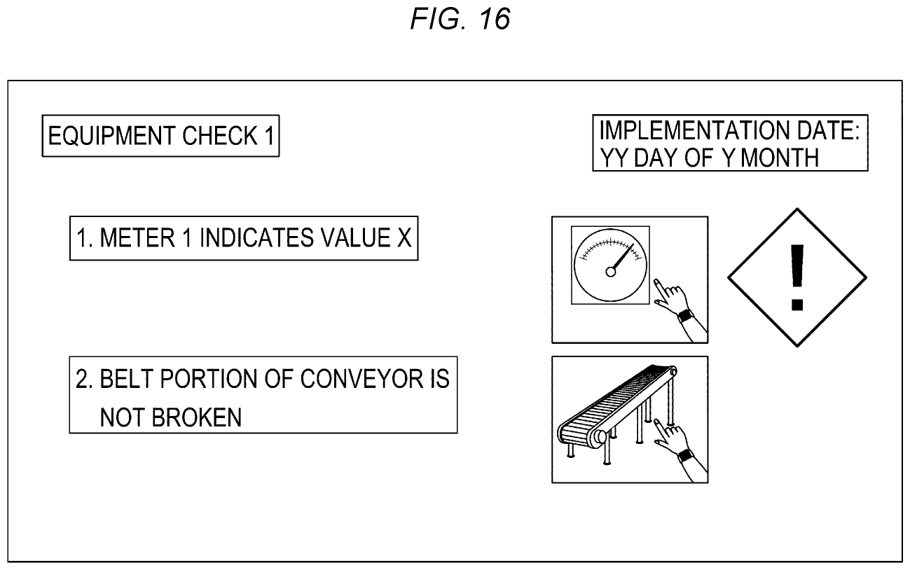

FIG. 16 is a diagram illustrating an example of work implementation evidence of the information processing system according to the embodiment. In the example illustrated in FIG. 16, evidence of work implemented on “YY day of Y month” is illustrated for a procedure “equipment check 1”. Image data at the time when pointing and calling was performed is illustrated side by side with a first item “1. The meter 1 indicates the value X”. If focusing on an image at the time when pointing and calling was performed, a value indicated by the meter 1 is a value Y higher than the value X. “!” indicating alert is displayed for the first item. Image data at the time when pointing and calling was performed is illustrated side by side with a second item “2. The belt portion of the conveyor is not broken”. Alert is not displayed for the second item.

Referring back to FIG. 12, if the processing in ACT54 ended, the series of processing illustrated in FIG. 12 ends.

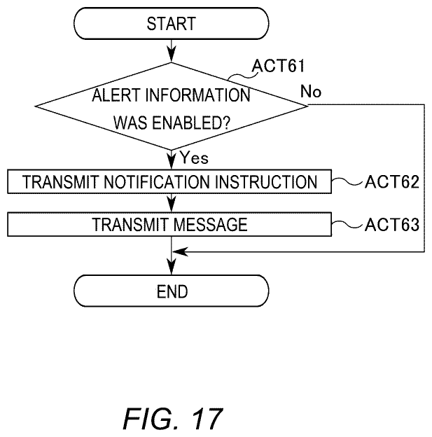

FIG. 17 is a flowchart illustrating an example of an alert detection operation of the server 3 according to the embodiment. The alert detection operation is executed, for example, periodically in the server 3 (e.g., in predefined intervals of time, continuously, nearly continuously, etc.). If the alert detection operation is executed, the server 3 determines whether alert information was enabled (ACT61). Specifically, the processor 31 of the server 3 determines, referring to the evidence database 333, whether there is a new item for which alert information was enabled.

If the alert information was enabled (ACT61, Yes), the server 3 transmits a notification instruction (ACT62). Specifically, the processor 31 controls the communication interface 34 to transmit, to external equipment, for example, the smart glasses 1, the terminal 4, or the like, information for instructing the external equipment to notify that the alert information was enabled. The equipment having received this information notifies a user of the equipment that the alert information was enabled. As a method of the notification, the notification may be displayed on a display device such as a display or may be notification by sound, light, or vibration. If the notification is performed using the display device such as the display, information relating to the alert information, for example, a name of a procedure, time information, a sentence of an item, or the like may be notified together.

The server 3 transmits a message (ACT63). Specifically, the processor 31 controls the communication interface 34 to transmit a message including the alert information being enabled. The message can take any form such as an electronic mail, an SMS (short message service), or a message of a chat application. The message may be a simple message only indicating that the alert information is enabled or may include information relating to the alert information such as a name of a procedure, time information, or a sentence of an item.

If the alert information was not enabled in the processing in ACT61 (ACT61, No) and if the processing in ACT63 ended, the series of processing illustrated in FIG. 17 ends.

As it is evident from the above explanation, the processor 31 of the server 3 executes the processing in ACT31 to ACT33 in FIG. 8 to function as a reception processing unit. That is, the processor 31 receives an image captured based on the pointing and calling action.

The processor 31 of the server 3 executes the processing in ACT43 in FIG. 12 to function as a generation processing unit. That is, the processor 31 generates an explanatory sentence from the image received by the reception processing unit.

The processor 31 of the server 3 executes the processing in ACT44, ACT48, ACT49 and ACT50 in FIG. 12 to function as a similarity degree processing unit. That is, the processor 31 calculates similarity degrees between the generated explanatory sentence and work item sentences, which are sentences of items included in a check procedure and finds a combination having the highest similarity degree.

The processor 31 of the server 3 executes the processing in ACT51 and ACT52 in FIG. 12 to function as an alert processing unit. That is, the processor 31 enables alert information if the similarity degree of the found combination is lower than a threshold.

The processor 31 of the server 3 executes the processing in ACT54 in FIG. 12 to function as an evidence processing unit. That is, the processor 31 combines a set of a work item sentence and an image corresponding to the found combination, time information, and, if enabled, the alert information and generates work implementation evidence indicating that the check procedure was implemented by a user.

The processor 31 of the server 3 executes the processing in ACT61 and ACT62 in FIG. 17 to function as an instruction processing unit. That is, if the alert information was enabled, the processor 31 outputs, to the external equipment, an instruction for causing the external equipment to notify the user.

The processor 31 of the server 3 executes the processing in ACT61 and ACT63 in FIG. 17 to function as a message processing unit. That is, if the alert information was enabled, the processor 31 transmits a message to the external equipment.

As it is evident from the above explanation, the processor 31 of the server 3 executes the processing in ACT31 to ACT33 in FIG. 8 to thereby configure reception processing means. That is, the server 3 receives an image captured based on the pointing and calling action.

The processor 31 of the server 3 executes the processing in ACT43 in FIG. 12 to thereby configure generation processing means. That is, the server 3 generates an explanatory sentence from an image received by the reception processing means.

The processor 31 of the server 3 executes the processing in ACT44, ACT48, ACT49, and ACT50 in FIG. 12 to thereby configure similarity degree processing means. That is, the server 3 calculates similarity degrees between the generated explanatory sentence and work item sentences, which are sentences of items included in the check procedure and finds a combination having the highest similarity degree.

The processor 31 of the server 3 executes the processing in ACT51 and ACT52 in FIG. 12 to thereby configure alert processing means. That is, the server 3 enables alert information if the similarity degree of the found combination is lower than a threshold.

The server 3 according to an embodiment includes a reception processing unit configured to receive an image captured based on a pointing and calling action, a generation processing unit configured to generate an explanatory sentence from the image received by the reception processing unit, a similarity degree processing unit configured to calculate similarity degrees between the generated explanatory sentence and work item sentences, which are sentences of items included in a check procedure, and find a combination having the highest similarity degree, and an alert processing unit configured to enable alert information if the similarity degree of the found combination is lower than a threshold. Accordingly, the server 3 according to the embodiment can combine the image captured based on the pointing and calling action with the item included in the check procedure and enable the alert information if the similarity degree is lower than the threshold. That is, the server 3 according to the embodiment can automatically link an image serving as evidence of implementing the pointing and calling action with the item included in the check procedure and, moreover, enable the alert information if it is doubtful whether check was correctly performed. Thus, the server 3 according to the embodiment can provide a function of being able to detect a case in which it is doubtful whether check by pointing and calling was correctly performed.

The server 3 according to an embodiment further includes an evidence processing unit configured to combine a set of the work item sentence corresponding to the found combination and the image, time information, and, if enabled, the alert information and generate work implementation evidence indicating that the check procedure was implemented. Accordingly, the server 3 according to the embodiment can collectively save a set of time information when the check procedure was implemented, a set of a work item and an image, and the alert information. The user who refers to the work implementation evidence can easily grasp an implementation result of the check procedure.

The server 3 according to an embodiment further includes an instruction processing unit configured to, if the alert information was enabled, output, to external equipment, an instruction for causing the external equipment to notify the user. Accordingly, the server 3 according to the embodiment can quickly notify the user that the alert information was enabled.

The server 3 according to an embodiment further includes a message processing unit configured to transmit a message to external equipment if the alert information was enabled. Accordingly, the server 3 can inform the user, with character information, that the alert information was enabled. If the server 3 according to the embodiment includes information relating to the alert information, for example, a name of a procedure, time information, a sentence of an item, and the like in the message, the user having received the message can grasp, without referring to work implementation evidence, a situation in which alerts occur.

In the embodiment, a case in which the server 3 includes one computer is explained as an example. The server 3 may include a plurality of servers. For example, the image database 331, the procedure database 332, and the evidence database 333 may be respectively stored in storages of different servers. In the case of this example, if acquiring information from the databases, instead of referring to the storage 33, the server 3 transmits an instruction for requesting data to a remote server via a communication interface 34. For example, processing by generative AI may be performed by an external server. In the case of this example, if generating an explanatory sentence using the generative AI, instead of executing an application of the generative AI, the processor 31 transmits image data to be input to the generative AI to the remote server via the communication interface 34, and the communication interface 34 receives a sentence generated by the generative AI from the remote server.

In the embodiment, a case in which the terminal 4 communicates with the server 3 to display the various screens is explained as an example. A case in which the mechanism for displaying the various screens is implemented by accessing the server 3 with the web browser is explained as an example. A method of displaying the screens is not limited to this. Various methods can be used. For example, the screens may be displayed using a dedicated application rather than the web browser. For example, the screens may be displayed using another device such as the smart glasses 1 rather than the terminal 4. For example, instead of the terminal 4 accessing information through the network 5, a display, a mouse, and a keyboard may be connected to the server 3 and the server 3 may directly display the screens on the display.

In the embodiment, a case in which the pointing and calling action is detected using the band 2 is explained as an example. The detection of the pointing and calling action is not limited to detection by the band 2. For example, the pointing and calling action may be detected by image recognition based on a moving image that can be acquired using the imaging unit 14 of the smart glasses 1.

In an embodiment, a case in which the smart glasses 1 are used as an example of the device that acquires image data and transmits the image data to the server 3 is explained as an example. A device other than the smart glasses 1 may be used if the device can acquire image data and transmit the image data to the server 3. For example, the device may be a device including an imaging unit fixed to a head, a helmet, or the like or may be a device including an imaging unit fixed to a chest.

In an embodiment, an image in which a state of the user performing pointing and calling is reflected is exemplified and explained as an example of the acquired image data. If the pointing and calling action is detected by a method other than the image recognition as in a case in which the pointing and calling action is detected using the band 2 as explained above, an arm or a finger of the user may not be reflected in the acquired image data.

In an embodiment, a case in which the processor 31 of the server 3 executes the processing using the generative AI is explained as an example. The processing using the generative AI may be executed by a dedicated circuit. For example, the server 3 may further include a generative AI execution circuit for executing the generative AI and the processor 31 may control the generative AI execution circuit to execute the processing using the generative AI.

In an embodiment, a case in which the feature space is three-dimensional is exemplified and explained with reference to FIG. 14. The feature space is not limited to three-dimensional. A space of any order number can be used.

In an embodiment, a case in which a check procedure name, an implementation date, a sentence of a check item, image data linked with the check item, and a sign indicating alert information are displayed as an example of the work implementation evidence is explained as an example. The work implementation evidence may further include information. For example, as the work implementation evidence, time information may be indicated not only as a date but also as an hour may be indicated for each piece of image data, a sentence generated from the image data by the generative AI may be indicated, or a value of a similarity degree between an item and the image data may be indicated.

A program according to an embodiment may be transferred in a state of being stored in electronic equipment such as the server 3 or may be transferred in a state of not being stored in the electronic equipment. In the latter case, the program may be transferred via a network or may be transferred in a state of being stored in a storage medium. The storage medium is a non-transitory tangible medium. The storage medium is a computer-readable medium. The storage medium only has to be a medium capable of storing a program and readable by a computer, such as an optical disk or a memory card, and a form of the storage medium does not matter. The electronic equipment downloads the program transferred (provided) via the network and installs the program in a memory or reads the program from the storage medium and installs the program in the memory.

Note that some or all of the embodiments and the modifications can be described as indicated by the following appendixes but are not limited to the following.

### Appendix 1

A server including:
a reception processing unit configured to receive an image captured based on a pointing and calling action;
a generation processing unit configured to generate an explanatory sentence from the image received by the reception processing unit;
a similarity degree processing unit configured to calculate similarity degrees between the generated explanatory sentence and work item sentences, which are sentences of items included in a check procedure, and find a combination having a highest similarity degree; and
an alert processing unit configured to enable alert information if the similarity degree of the found combination is lower than a threshold.

### Appendix 2

The server described in Appendix 1, further including an evidence processing unit configured to combine a set of the work item sentence corresponding to the found combination and the image, time information, and, if enabled, the alert information and generate work implementation evidence indicating that the check procedure was implemented.

### Appendix 3

The server described in Appendix 2, wherein the time information is information extracted from the image included in the set.

### Appendix 4

The server described in any one of Appendixes 1 to 3, further including an instruction processing unit configured to, if the alert information was enabled, output, to external equipment, an instruction for causing the external equipment to notify the user.

### Appendix 5

The server described in any one of Appendixes 1 to 3, further including a message processing unit configured to transmit a message to external equipment if the alert information was enabled.

### Appendix 6

The server described in any one of Appendixes 1 to 3, wherein the image received by the reception processing unit is an image captured based on detecting a pointing and calling action based on acceleration information.

### Appendix 7

The server described in Appendix 6, wherein the acceleration information is acquired from a band worn on a wrist of a user.

### Appendix 8

The server described in any one of Appendixes 1 to 3, wherein the image received by the reception processing unit is an image captured by a wearable terminal.

### Appendix 9

The server described in any one of Appendixes 1 to 3, wherein the similarity degree processing unit uses a feature vector for the calculation of the similarity degree.

### Appendix 10

A method including:
receiving an image captured based on a pointing and calling action;
generating an explanatory sentence from the received image;
calculating similarity degrees between the generated explanatory sentence and work item sentences, which are sentences of items included in a check procedure, and find a combination having a highest similarity degree; and
enabling alert information if the similarity degree of the found combination is lower than a threshold.

While certain embodiments have been described, these embodiments have been presented by way of example only and are not intended to limit the scope of the disclosure. Indeed, the novel embodiments described herein may be embodied in a variety of other forms; furthermore, various omissions, substitutions and changes in the form of the embodiments described herein may be made without departing from the spirit of the disclosure. The accompanying claims and their equivalents are intended to cover such forms or modifications as would fall within the scope and spirit of the disclosure.

What is claimed is:

1. A server comprising at least one processor coupled with at least one memory device storing instructions that, when executed by the at least one processor, cause the server to:
receive an image captured based on a pointing and calling action;
generate an explanatory sentence based on the image;
calculate similarity degrees between the explanatory sentence and a plurality of work item sentences, the plurality of work item sentences including items for a check procedure;
determine a combination of the explanatory sentence and a work item sentence of the plurality of work item sentences having a highest similarity degree relative to combinations of the explanatory sentence and other work item sentences of the plurality of work item sentences; and
enable alert information based on the similarity degree of the explanatory sentence and the work item sentence being lower than a threshold.

2. The server of claim 1, wherein the instructions, when executed by the at least one processor, cause the server to:
combine the work item sentence and the image, and, if enabled, the alert information, the image including associated time information; and
generate work implementation evidence indicating that the check procedure was implemented.

3. The server of claim 2, wherein the associated time information is a date and time extracted from the image.

4. The server of claim 1, wherein the instructions, when executed by the at least one processor, cause the server to:
output, to external equipment, an instruction for causing the external equipment to notify a user based on the alert information being enabled.

5. The server of claim 1, wherein the instructions, when executed by the at least one processor, cause the server to transmit a message to external equipment based on the alert information being enabled.

6. A method comprising:
receiving an image captured based on a pointing and calling action;
generating an explanatory sentence based on the image;
calculating similarity degrees between the explanatory sentence and a plurality of work item sentences, the plurality of work item sentences including items for a check procedure;
determining a combination of the explanatory sentence and a work item sentence of the plurality of work item sentences having a highest similarity degree relative to combinations of the explanatory sentence and other work item sentences of the plurality of work item sentences; and
enabling alert information based on the similarity degree of the explanatory sentence and the work item sentence being lower than a threshold.

7. The method of claim 6, further comprising:
combining the work item sentence and the image, and, if enabled, the alert information, the image including associated time information; and
generating work implementation evidence indicating that the check procedure was implemented.

8. The method of claim 7, wherein the associated time information is a date and time extracted from the image.

9. The method of claim 6, further comprising outputting, to external equipment, an instruction for causing the external equipment to notify a user based on the alert information being enabled.

10. The method of claim 6, further comprising transmitting a message to external equipment based on the alert information being enabled.

11. A system, comprising:
a band configured to detect a pointing and calling action;
a pair of smart glasses configured to capture at least one image based at least partially on the band detecting the pointing and calling action; and
a server comprising at least one processor coupled with at least one memory device storing instructions that, when executed by the at least one processor, cause the server to:
receive a check procedure including a plurality of work item sentences;
receive, from the smart glasses, the at least one image captured based on the pointing and calling action, the pointing and calling action corresponding to at least one of the plurality of work item sentences;
generate an explanatory sentence based on the at least one image;
calculate similarity degrees between the explanatory sentence and the plurality of work item sentences;
determine a combination of the explanatory sentence and a work item sentence of the plurality of work item sentences having a highest similarity degree relative to combinations of the explanatory sentence and other work item sentences; and
cause a user device to display a notification to a user indicating that the pointing and calling action was not performed correctly based on the similarity degree of the explanatory sentence and the work item sentence being lower than a threshold.

12. The system of claim 11, wherein the instructions, when executed by the at least one processor, cause the server to:
combine the work item sentence and the at least one image, the at least one image including associated time information; and
generate work implementation evidence indicating that the check procedure was implemented.

13. The system of claim 12, wherein the associated time information is a date and time extracted from the at least one image included in a set of images.

14. The system of claim 11, wherein the band the band includes a user interface and is configured to cause the smart glasses to capture the at least one image based at least partially on a user input via the user interface.

15. The system of claim 11, wherein the band is configured to detect acceleration information indicative of a wrist motion by the user and to cause the smart glasses to capture the at least one image based at least partially on the wrist motion.

16. The system of claim 11, wherein the smart glasses include a user interface and the smart glasses capture the at least one image based at least partially on a user input via the user interface.
